(19) United States
(12) Patent Application Publication
(10) Pub. No.: US 2011/0189417 A1
(43) Pub. Date: Aug. 4, 2011

(54) PROCESS FOR PREPARING CONTAINER HAVING A FOAMED WALL

(76) Inventor: Frank E. Semersky, Holland, OH (US)

(21) Appl. No.: 12/674,096

(22) PCT Filed: Aug. 20, 2008
(86) PCT No.: PCT/US08/73667

§ 371 Date: Feb. 18, 2010

Related U.S. Application Data
(60) Provisional application No. 60/956,984, filed on Aug. 21, 2007.

(51) Int. Cl. B32B 1/00; B29D 22/00; B29C 44/34; B29C 49/06

(52) U.S. Cl. 428/36.5; 264/535; 264/51

(57) ABSTRACT

A process for making a container comprises injection molding a polymer preform having a non-reactive gas entrapped within the walls thereof; cooling the preform to a temperature below the polymer softening temperature, the cooled preform having an initial material volume; reheating the cooled preform to a temperature greater than the polymer softening temperature; and blow molding the reheated preform, to prepare a container consisting essentially of a microcellular foamed polymer having a non-reactive gas contained within the foam cells, wherein the material volume of the container is greater than the initial material volume of the cooled preform measured at the same temperature.

### CROSS-REFERENCE TO RELATED APPLICATION

This application claims the benefit of U.S. Provisional Patent Application Ser. No. 60/956,984 filed on Aug. 21, 2007 hereby incorporated herein by reference.

### FIELD OF THE INVENTION

The present invention relates generally to a process for preparing a polymer container having a foamed wall. More particularly, the invention is directed to a process for preparing a container consisting essentially of microcellular foam, wherein the material volume of the container is greater than the initial material volume of the cooled preform measured at the same temperature.

### BACKGROUND OF THE INVENTION

Biaxially oriented single and multi-layered containers may be manufactured from polymer materials such as, for example, polyethylene terephthalate (PET) using a hot preform process, wherein a single or multi-layered preform is heated to its desired orientation temperature and drawn and blown into conformity with a surrounding mold cavity. The preform may be prepared by any conventional process such as, for example, by extruding a preform comprising single or multiple layers of polymer, or by injecting subsequent layers of polymer over a previously injection molded preform. Generally, multiple layers are used for beverage containers, to add diffusion barrier properties not generally found in single layer containers.

The various layers of polymers in the prior art multi-layered containers are generally in intimate contact with one another, thereby facilitating the conduct of thermal energy through the walls of the containers. This allows the chilled contents of the container to quickly warm to the ambient temperature. Accordingly, such containers are often sheathed in, for example, a foamed polystyrene shell to impart thermal insulating properties to the container.

It would be desirable to prepare an improved, single-layer container, having both carbon dioxide diffusion barrier properties and thermal insulating properties.

### SUMMARY OF THE INVENTION

Concordant and congruous with the present invention, a process for making a container exhibiting the properties set forth above has surprisingly been discovered. The process comprises the steps of: injection molding a polymer preform having a non-reactive gas entrapped within the walls thereof; cooling the preform to a temperature below the polymer softening temperature, the cooled preform having an initial material volume; reheating the preform to a temperature greater than the polymer softening temperature; and blow molding the preform, to prepare a container consisting essentially of a microcellular foamed polymer having a non-reactive gas contained within the foam cells, wherein the material volume of the container is greater than the initial material volume of the cooled preform measured at the same temperature.

The present invention contemplates a container, consisting essentially of a microcellular foamed polymer, and a non-reactive gas contained within the microcellular foam cells, wherein the material volume of the container is greater than the initial material volume of the cooled preform from which the container was blow molded, measured at the same temperature.

In one embodiment of the invention, a process for preparing a polymer container having a foamed wall, comprises the steps of injection molding a polymer preform having a non-reactive gas entrapped within the walls thereof; cooling the preform to a temperature below the polymer softening temperature, the cooled preform having an initial material volume; reheating the cooled preform to a temperature greater than the polymer softening temperature; and blow molding the reheated preform, to prepare a container consisting essentially of a microcellular foamed polymer having a non-reactive gas contained within foam cells formed therein and having a material volume greater than the initial material volume of the cooled preform measured at the same temperature.

In another embodiment of the invention, a process for preparing a container having a foamed wall, comprises the steps of injection molding a polyethylene terephthalate polymer preform having a non-reactive gas entrapped within the walls thereof; cooling the preform to a temperature below the polymer softening temperature, the cooled preform having an initial material volume; reheating the cooled preform to a temperature greater than the polymer softening temperature; and blow molding the reheated preform, to produce a container consisting essentially of a microcellular foamed polymer having a non-reactive gas contained within foam cells formed therein and having a material volume greater than the initial material volume of the cooled preform measured at the same temperature.

In another embodiment of the invention, a container prepared by a process, comprises the steps of injection molding a polymer preform having a non-reactive gas entrapped within the walls thereof; cooling the preform to a temperature below the polymer softening temperature, the cooled preform having an initial material volume; reheating the cooled preform to a temperature greater than the polymer softening temperature; and blow molding the reheated preform, to prepare a container consisting essentially of a microcellular foamed polymer having a non-reactive gas contained within foam cells formed therein and having a material volume greater than the initial material volume of the cooled preform measured at the same temperature.

The process and container according to the present invention are particularly useful for packaging carbonated beverages.

### DETAILED DESCRIPTION OF THE PREFERRED EMBODIMENT

The present invention is directed to a process for making a container, comprising: injection molding a polymer preform having a non-reactive gas entrapped within the walls thereof; cooling the preform to a temperature below the polymer softening temperature, said cooled preform having an initial material volume; reheating the preform to a temperature greater than the polymer softening temperature; and blow molding the preform, to prepare a container consisting essentially of a microcellular foamed polymer having a non-reactive gas contained within the foam cells, wherein the material volume of the container is greater than the initial material volume of the cooled preform measured at the same temperature.

Suitable polymers from which the container may be prepared include, but are not necessarily limited to, polyethylene terephthalate (PET) and other polyesters, polypropylene, acrylonitrile acid esters, vinyl chlorides, polyolefins, polyamides, and the like, as well as derivatives, blends, and copolymers thereof. A preferred polymer is PET.

Polymer flakes are melted in a conventional plasticizing screw extruder, to prepare a homogeneous stream of hot polymer melt at the extruder discharge. Typically, the temperature of the polymer melt stream discharged from the extruder ranges from about 225 degrees Centigrade to about 325 degrees Centigrade. One ordinarily skilled in the art will appreciate that the temperature of the polymer melt stream will be determined by several factors, including the kind of polymer flakes used, the energy supplied to the extruder screw, etc. As an example, PET is conventionally extruded at a temperature from about 260 degrees Centigrade to about 290 degrees Centigrade. A non-reactive gas is injected under pressure into the extruder mixing zone, to ultimately cause the entrapment of the gas as microcellular voids within the polymer material. By the term “non-reactive gas” as it is used herein is meant a gas that is substantially inert vis-à-vis the polymer. Preferred non-reactive gases comprise carbon dioxide, nitrogen, and argon, as well as mixtures of these gases with each other or with other gasses.

According to the present invention, the extrudate is injection molded to form a polymer preform having the non-reactive gas entrapped within the walls thereof. Methods and apparatus for injection molding a polymer preform are well-known in the art.

It is well-known that the density of amorphous PET is about 1.335 grams per cubic centimeter. It is also known that the density of PET in the melt phase is about 1.200 grams per cubic centimeter. If the preform injection cavity is filled completely with molten PET and allowed to cool, the resulting preform will not exhibit the proper weight and will have many serious deficiencies, such as sink marks. The prior art injection molding literature teaches that, in order to offset the difference in the densities of amorphous and molten PET, a small amount of polymer material must be added to the part after the cavity has been filled and as the material is cooling. This is called the packing pressure. It has been discovered that about ten percent more material must be added during the packing pressure phase of the injection molding cycle in order to insure that a preform made by injection molding is filled adequately and fully formed. The packing pressure phase of the injection molding operation is likewise used for polymer materials other than PET.

According to the present invention, a polymer preform is injection molded and simultaneously foamed using a non-reactive gas. The gas is entrained in the material during the injection phase. Contrary to the prior art injection molding process, wherein additional polymer material is injected during the packing phase, the present invention utilizes minimal packing pressure. As the polymer material is still in a molten state, the partial pressure of the non-reactive gas is sufficient to permit the release of the dissolved gas from the polymer into the gas phase where it forms the microcellular foam structure. Thus, the preform made by the inventive process weighs less than, but has the same form and geometry as, the polymer preforms produced by the conventional injection molding operations that employ the packing process.

In addition to the preferred gases, the microcells may contain other gases typically used in processes for making microcellular foam structures. Preferably, the non-reactive gas comprises carbon dioxide in a concentration of at least ten percent by weight of the total weight of the non-reactive gas. Moreover, depending on the microcellular foam structure, the microcellular foam may act as an effective thermal insulator, to retard the conduct of heat energy from the atmosphere to the chilled carbonated beverage within the container

Upon completion of the injection molding step, the preform is cooled to a temperature below the polymer softening temperature. For example, the softening temperature for PET is approximately 70 degrees Centigrade. The entrapped non-reactive gas is retained within the walls of the polymer preform. The cooling step conditions the polymer and preserves its desirable properties for the successful preparation of a blow molded container. The cooling step is also necessary when employing polymers such as polyesters, which cannot be blow molded directly from an extruded parison. The cooling step may be effected by any conventional process used in the polymer forming art such as, for example, by passing a stream of a cooling gas over the surfaces of the preform, or cooling the preform while in-mold by cooling the forming mold. The foamed preform is prepared having an initial material volume, determined by dividing the mass of the foamed polymer preform by its density.

The volume of any plastic article, including a blow molding preform, may easily be calculated by dividing value of the mass of the plastic article by the density of the material from which it is made. For example, a conventional, non-foamed PET preform with a mass of about 26.7 grams will have a volume of approximately 20.0 cubic centimeters; because the density of the non-foamed PET in the amorphous state is approximately 1.335 grams per cubic centimeter. When such a non-foamed preform is blow molded, there is a very slight increase in the density of the material as a result of crystallinity that is introduced during the blow molding process. Only a portion of the preform is highly stretched, and therefore subjected to the density increase. Assuming that the un-oriented portions of the non-foamed preform, namely, the finish, support legs, neck, and part of the end cap, weigh about 6 grams. The remainder of the mass of the preform, i.e., about 20.7 grams, would have an average orientation of about 20% at which the density of the PET is about 1.359 grams per cubic centimeter. Thus, the volume of a blow molded container prepared from such a non-foamed PET preform would be 6/1.335+20.7/1.359, or approximately 19.73 cubic centimeters. The volume is less than the volume (20.0 cubic centimeters) of the non-foamed preform from which the blow molded container is made.

The foamed preform is made with the introduction of supercritical, non-reactive, nitrogen gas or carbon-dioxide gas. Holding pressure is reduced to about 308 bar and held for only about 0.5 second. Cooling time of the preform is increased to approximately 25.0 seconds. The preform is aesthetically acceptable, and does not exhibit any physical deficiencies. The foamed preform according to the present invention may have a level of foam from about 1% to about 10%, preferably about 4%. The foam level is defined as the percentage difference of the weight of the foamed preform compared to the weight of an unfoamed preform prepared from the same material, both the foamed and unfoamed preforms having the same volume. For example, a foamed preform having level of foam of 4% weighs 4% less than an unfoamed preform formed from the same material with both the foamed and unfoamed preforms having the same volume. At the 4% level of foam, the material density is about 1.2816 grams per cubic centimeter. Therefore, a 4% foamed preform having a volume of about 20.0 cubic centimeters would have a mass of only about 25.63 grams.

The foamed preform according to the present invention is reheated to a temperature above the polymer softening temperature. The heating step may be effected by well-known means such as, for example, by exposure of the preform to a hot gas stream, by flame impingement, by exposure to infra-red energy, by passing the preform through a conventional oven, or the like. PET is generally reheated to a temperature twenty to twenty-five degrees (20-25° C.) above its softening temperature for the subsequent blow molding operation. If PET is reheated too far above its glass transition temperature, or held at a temperature above its softening temperature for an excessive period of time, the PET undesirably will begin to crystallize and turn white. Likewise, if the preform is heated to a temperature above which the mechanical properties of the material are exceeded by the increasing pressure of the non-reactive gas in the microcells, the microcells undesirably will begin to expand and thus distort the preform.

Finally, the foamed preform is blow molded to produce a container consisting essentially of a microcellular foamed polymer having a non-reactive gas contained within the microcellular foam cells. Methods and apparatus for blow molding a container from a polymer preform are well-known.

Surprisingly, the blow molded container has a material volume greater than that of the preform from which it is produced. Unlike the case where a conventional, non-foamed preform is blow molded. In such instance a container is produced having a lesser material volume (20.0 cubic centimeters reduced to 19.73 cubic centimeters as set forth above). A blow molded container prepared from the foamed polymer preform according to the present invention has a greater material volume. A 4% foamed PET preform having a material volume of about 20.0 cubic centimeters will produce a blow molded container having a volume in excess of 20.0 cubic centimeters, measured at the same temperature.

The volume increase according to the present invention is unexpected to one ordinarily skilled in the art. The container is formed by blow molding a preform that has been heated above its softening point. During the blow molding process, gas pressure up to about 600 psi is exerted on the inside of the container, forcing the foamed preform walls into conformity with the mold cavity walls. One ordinarily skilled in the art would assume that the high internal pressure exerted during the blow molding process would partially collapse the foam cells resulting in thinner and more dense container side walls. Also, the orientation and increased crystallinity of the polymer matrix during the blow molding process would lead one ordinarily skilled in the art to expect the material volume of a container made from a foamed preform to be less than the material volume of the preform from which it is made.

From the forgoing description, one ordinarily skilled in the art can easily ascertain the essential characteristics of the invention, and without departing from its spirit and scope, can make various changes and modifications to adapt the invention to various uses and conditions.

What is claimed is:

1. A process for preparing a polymer container having a foamed wall, comprising the steps of:
injection molding a polymer preform having a non-reactive gas entrapped within the walls thereof;
cooling the preform to a temperature below the polymer softening temperature, the cooled preform having an initial material volume;
reheating the cooled preform to a temperature greater than the polymer softening temperature; and
blow molding the reheated preform, to prepare a container consisting essentially of a microcellular foamed polymer having a non-reactive gas contained within foam cells formed therein and having a material volume greater than the initial material volume of the cooled preform measured at the same temperature.

2. The process of claim 1, wherein the polymer comprises a polymer selected from polyesters, polypropylene, acrylonitrile acid esters, vinyl chlorides, polyolefins, polyamides, and derivatives, blends, and copolymers thereof.

3. The process of claim 1, wherein the polymer comprises polyethylene terephthalate.

4. The process of claim 1, wherein the non-reactive gas comprises one of carbon dioxide, nitrogen, argon, and a mixture thereof.

5. The process of claim 1, wherein the non-reactive gas comprises carbon dioxide.

6. The process for of claim 1, wherein the non-reactive gas is a supercritical gas.

7. The process of claim 1, wherein a partial pressure of the non-reactive gas in the polymer melt is sufficient to facilitate the release of the non-reactive gas from the polymer melt into the gas phase to foam the polymer melt.

8. The process of claim 1, wherein the foam level of the preform is from about 1% to about 10% foam.

9. The process of claim 8, wherein the foam level of the preform is from about 2% to about 6% foam.

10. The process of claim 9, the foam level of the preform is about 4% foam.

11. A process for preparing a container having a foamed wall, comprising the steps of:
injection molding a polyethylene terephthalate polymer preform having a non-reactive gas entrapped within the walls thereof;
cooling the preform to a temperature below the polymer softening temperature, the cooled preform having an initial material volume;
reheating the cooled preform to a temperature greater than the polymer softening temperature; and
blow molding the reheated preform, to produce a container consisting essentially of a microcellular foamed polymer having a non-reactive gas contained within foam cells formed therein and having a material volume greater than the initial material volume of the cooled preform measured at the same temperature.

12. The process of claim 11, wherein the non-reactive gas comprises one of carbon dioxide, nitrogen, argon, and a mixture thereof.

13. The process of claim 11, wherein the non-reactive gas comprises carbon dioxide.

14. The process of claim 11, wherein the non-reactive gas is a supercritical gas.

15. The process of claim 11, wherein a partial pressure of the non-reactive gas in the polymer melt is sufficient to facilitate the release of the non-reactive gas from the polymer melt into the gas phase to foam the polymer melt.

16. The process of claim 11, wherein the foam level of the preform is about 4% foam.

17. The process of claim 16, wherein the blow molded container formed from the foamed preform results in a blow molded container having a volume in excess of 20.0 cubic centimeters.

18. A container prepared by a process, comprising the steps of:
injection molding a polymer preform having a non-reactive gas entrapped within the walls thereof;
cooling the preform to a temperature below the polymer softening temperature, the cooled preform having an initial material volume;
reheating the cooled preform to a temperature greater than the polymer softening temperature; and
blow molding the reheated preform, to prepare a container consisting essentially of a microcellular foamed polymer having a non-reactive gas contained within foam cells formed therein and having a material volume greater than the initial material volume of the cooled preform measured at the same temperature.

19. The container of claim 18, wherein the foam level of the preform is from about 1% to about 10% foam.

20. The container of claim 19, wherein the foam level of the preform is about 4% foam.
